(19) United States
(12) Patent Application Publication
(10) Pub. No.: US 2012/0322699 A1
(43) Pub. Date: Dec. 20, 2012

(54) Method of Preventing Scale Formation During Enhanced Oil Recovery

(75) Inventors: Oya A. Karazincir, Houston, TX (US); Sophany Thach, Houston, TX (US); Wei Wei, Sugar Land, TX (US); Gabriel Prukop, Katy, TX (US); Taimur Malik, Houston, TX (US); Varadarajan Dwarakanath, Houston, TX (US)

(73) Assignee: Chevron U.S.A. Inc., San Ramon, CA (US)

(21) Appl. No.: 13/396,114

(22) Filed: Feb. 14, 2012

Related U.S. Application Data
(60) Provisional application No. 61/442,571, filed on Feb. 14, 2011.

(51) Int. Cl. C09K 8/52

(52) U.S. Cl. 507/227; 507/241; 507/237

(57) ABSTRACT

A method for preventing scale formation during an alkaline hydrocarbon recovery process is disclosed. An aqueous solution (e.g., recovered sea water, water produced from the subterranean reservoir, or a combination thereof) having a concentration of metal cations (e.g., calcium, magnesium) is provided. A stoichiometric amount of an organic complexing agent relative to the concentration of metal cations is introduced into the aqueous solution such that the organic complexing agent forms aqueous soluble cation-ligand complexes with the metal cations. At least one alkaline is introduced into the aqueous solution to form an injection fluid having a pH value of at least 10. The cation-ligand complexes remain soluble in the injection fluid such that scale formation is prevented when the injection fluid is injected into a subterranean reservoir.

### CROSS-REFERENCE TO RELATED APPLICATIONS

The present application for patent claims the benefit of U.S. Provisional Application bearing Ser. No. 61/442,571, filed on 14 Feb. 2011, which is incorporated by reference in its entirety.

### TECHNICAL FIELD

This invention relates to a method for preventing scale formation during an enhanced oil recovery process, and more particularly, to a method of preventing scale formation during an alkaline flood.

### BACKGROUND

Alkaline flooding is an enhanced oil recovery (EOR) process in which alkali is injected during a flooding process to improve the recovery of residual oil in hydrocarbon formations. As used herein, the term “alkaline flooding” includes injecting alkali in a water flood, polymer flood or a surfactant-polymer flood. The primary recovery mechanism of alkaline flooding is by improving microscopic displacement efficiency. Microscopic displacement efficiency is largely controlled by capillary forces between the reservoir fluids and the formation. In an alkaline flood, alkaline agents react with acidic components in the oil to form soap. The soap, which acts as a surfactant and is the primary driver for oil recovery, reduces the interfacial tension (IFT) between the water and oil in the reservoir allowing trapped oil globules to escape from pore-spaces in the reservoir rock. The soap also can alter the wettability of the reservoir rock, as well as, help with reducing the adsorption of other chemicals in the injection fluid by the reservoir rock.

Alkaline floods typically operate at a high pH (e.g., above a pH value of 10) to enable saponification of the acidic components in the crude oil. In reservoirs where the injected brine contains high concentrations of divalent cations, such as calcium and magnesium, such an increase in pH can result in severe scale formation. Furthermore, conventional scale inhibitors are typically ineffective at these elevated pH conditions. Therefore, to avoid scale formation, consequent plugging, and other problems, water treatment methods such as water softening/desalination can be used. However, these water treatment methods can be cost prohibitive and are very difficult to perform at off-shore fields.

### SUMMARY

A method for preventing scale formation during an alkaline hydrocarbon recovery process is disclosed. An aqueous solution (e.g., recovered sea water, water produced from the subterranean reservoir, or a combination thereof) having a concentration of metal cations (e.g., calcium, magnesium) is provided. A stoichiometric amount of an organic complexing agent relative to the concentration of metal cations is introduced into the aqueous solution such that the organic complexing agent forms aqueous soluble cation-ligand complexes with the metal cations. At least one alkaline is introduced into the aqueous solution to form an injection fluid having a pH value of at least 10. The cation-ligand complexes remain soluble in the injection fluid such that scale formation is prevented when the injection fluid is injected into a subterranean reservoir.

In some embodiments, the organic complexing agent is ethylenediaminetetraacetic acid. In some embodiments, the organic complexing agent is methylglycinediacetic acid. The organic complexing agent can be introduced into the aqueous solution in a concentration of a 1:1 molar ratio or less with the metal cations. In some embodiments, water softening of the aqueous solution is solely performed by sequestering the metal cations with the organic complexing agent.

In some embodiments, a scale inhibitor, such as a phosphonate or polyvinyl sulfonate based scale inhibitor, is introduced into the aqueous solution. For example, the scale inhibitor can be introduced in a concentration of from 100 parts per million to 600 parts per million. The organic complexing agent can be introduced into the aqueous solution in a concentration of less than a 1:1 molar ratio with the metal cations, such as a concentration of complexing agent to metal cations being as little as a 0.65:1 molar ratio.

### BRIEF DESCRIPTION OF THE DRAWINGS

FIG. 1 shows examples of organic complexing agents.

FIG. 2A shows an example of an aqueous stable solution. FIG. 2B shows an example of a “hazy” solution.

FIG. 3 shows the speciation of EDTA as a function of pH.

FIG. 4 shows the speciation of NTA as a function of pH.

FIG. 5 shows the speciation of citric acid as a function of pH.

FIG. 6 shows the speciation of phosphoric acid as a function of pH.

FIG. 7 shows bottle test results for example complexing agents and scale inhibitors.

### DETAILED DESCRIPTION

Embodiments of the present invention relate to preventing scale formation during an enhanced oil recovery (EOR) process. As will be described, organic complexing agents are utilized for chemical treatment (i.e., softening) of water, which is a component of the injection fluid used in the EOR process. In particular, the complexing agents sequester divalent ions in the injected brine keeping them shielded from anions such as carbonate or sulfate, thereby preventing scale formation. For example, the complexing agent binds calcium cations to prevent calcium-carbonate scaling. The complexing agent also binds magnesium cations to prevent magnesium-carbonate scaling. Accordingly, the complexing agent forms aqueous soluble cation-ligand complexes with the metal cations so that they will not interact with other ions to create precipitation.

Embodiments of the present invention are particularly useful for supplying usable water to facilities offshore and can act as a surrogate to water-softening as it is easier to implement in the field and can be much more cost-effective. In particular, offshore platforms or FPSOs generally have deck space and weight limitations. Locating additional deck space on or adding to existing platforms or FPSOs for the water-treatment facilities is often not viable. An auxiliary platform, barge, or even new platform or FPSO can alternatively be used to provide the additional deck space for the water-treatment facilities; however, in most cases this also is a very expensive solution. The deck space and weight of the facilities used for chemical storage, mixing and injection in the present invention are much less than that of traditional water-treatment facilities.

### Organic Complexing Agents

One or more organic complexing agents are added or mixed into the aqueous injection solution (e.g., recovered sea water, produced water) to sequester metal cations and form aqueous soluble cation-ligand complexes. When a complexing agent is added into formation brine, it competes with anions such as bicarbonates, carbonates or hydroxides present in brine to bind metal cations. Accordingly, the metal cations are sequestered by the binding agent and the whole complex remains in solution preventing scale formation. This eliminates the need for water softening and reduces the cost of a chemical flood.

The one or more organic complexing agents can be stoichiometrically added relative to the concentration of metal cations, such as calcium (Ca²⁺), magnesium (Mg²⁺), barium (Ba²⁺), and/or strontium (Sr²⁺), in the aqueous solution. In one embodiment, the organic complexing agents are added at a concentration of a 1:1 molar ratio or less with the metal cations. In some instances, the amount of organic complexing agent can be minimized by utilizing a small amount (e.g., 100-600 parts per million) of scale inhibitor in conjunction with the organic complexing agent. For example, the addition of the scale inhibitor can lower the concentration of complexing agent to metal cations from about a 1.00:1.00 molar ratio to as little as a 0.65:1.00 molar ratio. In some embodiments, the amount of organic complexing agent added is further tailored based on the brine composition and the desired pH of the injection solution.

Examples of organic complexing agents include metal salts of organic acids with multiple carboxylic acid moieties. This includes metal salts of poly(acrylic acid) and sulfonated poly(acrylic acid), metal salts of maelic acid and citric acid, and trisodium carboxymethyloxysuccinate. In one embodiment, organic complexing agents include ethylenediaminetetraacetic acid (EDTA), hydroxyethylethylenediaminetriacetic acid (HEDTA), diethylenedtriaminepentaacetic acid (DTPA), methylglycinediacetic acid (MGDA), nitrile triacetic acid (NTA), and sodium and potassium salts thereof. In one embodiment, the organic complexing agent comprises one or more of sodium ethylenediamine tetraacetate (EDTA-Na₄), sodium nitrilotriacetate (Na₃-NTA, Na₃C₆H₉NO₆), sodium citrate (Na₃C₆H₅O₇), sodium maleate monohydrate (C₄H₄Na₂O₅.H₂O), sodium succinate hexahydrate (C₄H₆O₄Na₂.6H₂O), and sodium polyacrylate [(—CH2—CH(CO2Na)—]. As will be described in more detail below, according to embodiments of the present invention, examples of suitable complexing agents are organic complexing agents that bind metal cations to form aqueous soluble cation-ligand complexes that remain soluble at a pH of at least 10, thereby preventing scale formation during alkaline flooding processes.

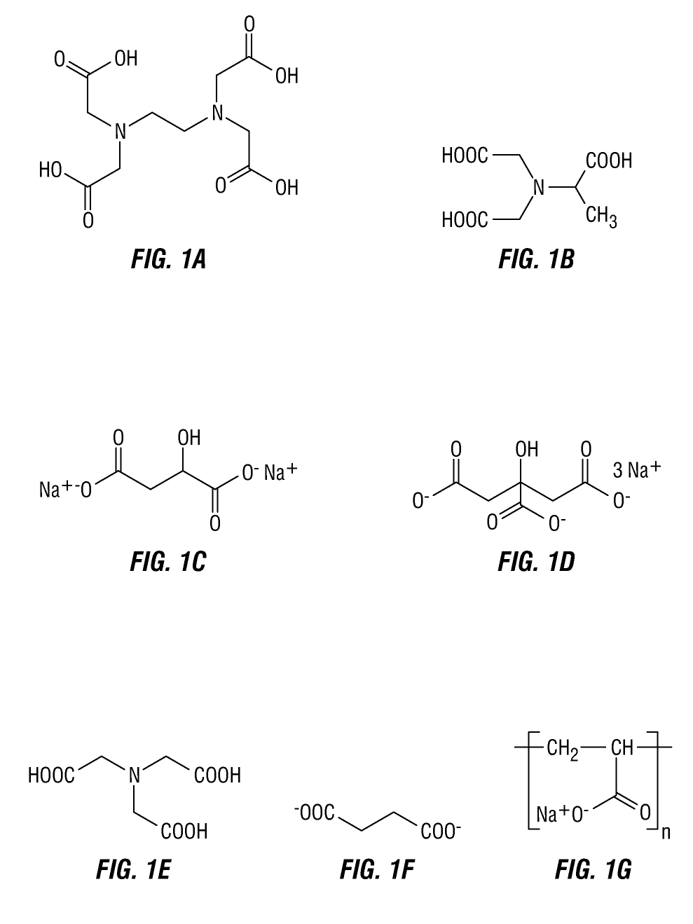

FIG. 1 shows the simplified chemical structures of example organic complexing agents. In particular, FIG. 1A shows the chemical structure for EDTA. FIG. 1B shows the chemical structure for MGDA. FIG. 1C shows the chemical structure for sodium maleate. FIG. 1D shows the chemical structure for sodium citrate. FIG. 1E shows the chemical structure for NTA. FIG. 1F shows the chemical structure for succinate. FIG. 1G shows the chemical structure for sodium polyacrylate. Organic complexing agents can form multiple bonds to a metal atom and are therefore considered “multidentate” ligands. For example, EDTA binds a metal ion through six bonds, whereas the metal atom is captured by three bonds in a tripolyphosphate-metal complex. The salinity of the injection solution can also be optimized for a particular subterranean reservoir by adjusting a number of chelating ligands in the complexing agent, such as alkoxylate groups if the complexing agent is EDTA.

### Scale Inhibitors

Scale inhibitors can be used to slow down or inhibit the growth rate of crystalline scale, such as calcite crystals, and other scale deposits. For example, scale inhibitors can delay nucleation of scale crystals or distort the crystalline lattice structure with functionalized polymers and other chemistries. As used herein, scale inhibitors are typically a dispersant rather than a sequestrant. Scale inhibitors are used in very small concentrations compared to the complexing agent. For example, based on the total volume of the injection fluid, the concentration of scale inhibitor can be between 0 and about 1000 parts per million (ppm), such as between about 100 and about 600 ppm.

In one embodiment, scale inhibitors include phosphate esters, phosphonic acid compounds, phosphonate acid compounds, polymeric compounds (e.g., polyacrylamides), or a combination thereof. For example, the scale inhibitor can comprise a polyacrylate-based inhibitor, polyvinyl sulfonate-based inhibitor, phosphonate-based inhibitor, or a combination thereof.

### Alkaline Flooding

Complexing agents can be utilized to prevent scale formation in an alkaline flooding process (i.e., alkali is injected during a water flooding, polymer flooding or a surfactant-polymer flooding hydrocarbon recovery operation). As previously discussed, the alkali penetrates into pore-spaces of the reservoir rock contacting the trapped oil globules. High acidic concentrations in the oil drive in situ saponification where the alkali and acidic components of the oil react to create natural soap, which the primary driver for oil recovery. The soap reduces the interfacial tension (IFT) between the water and oil in the reservoir allowing the trapped oil to escape from the pore spaces in the reservoir rock.

As used herein, the term “alkali” or “alkaline” refers to a carbonate or hydroxide of an alkali metal salt. The term “alkali metal” as used herein refers to Group IA metals of The International Union of Pure and Applied Chemistry (IUPAC) Periodic Table of Elements. In an embodiment, the alkali metal salt is an alkali metal hydroxide, carbonate or bicarbonate, including, but not limited to, sodium carbonate, sodium bicarbonate, sodium hydroxide, potassium hydroxide, or lithium hydroxide. Sodium chloride can also be used. The alkali is typically used in amounts ranging from about 0.3 to about 3.0 weight percent of the solution, such as about 0.5 to about 0.85 wt. %.

In some embodiments, a surfactant is added to the alkaline flood prior to injection of the aqueous solution into the reservoir to further reduce the interfacial tension between the water and oil in the reservoir. Examples of surfactants that can be utilized include anionic surfactants, cationic surfactants, amphoteric surfactants, non-ionic surfactants, or a combination thereof. Anionic surfactants can include sulfates, sulfonates, phosphates, or carboxylates. Such anionic surfactants are known and described in the art in, for example, SPE 129907 and U.S. Pat. No. 7,770,641. Example cationic surfactants include primary, secondary, or tertiary amines, or quaternary ammonium cations. Example amphoteric surfactants include cationic surfactants that are linked to a terminal sulfonate or carboxylate group. Example non-ionic surfactants include alcohol alkoxylates such as alkylaryl alkoxy alcohols or alkyl alkoxy alcohols. Currently available alkoxylated alcohols include Lutensol® TDA 10EO and Lutensol® OP40, which are manufactured by BASF SE headquartered in Rhineland-Palatinate, Germany Neodol 25, which is manufactured by Shell Chemical Company, is also a currently available alkoxylated alcohol. Chevron Oronite Company LLC, a subsidiary of Chevron Corporation, also manufactures alkoxylated alcohols such as L24-12 and L14-12, which are twelve-mole ethoxylates of linear carbon chain alcohols. Other non-ionic surfactants can include alkyl alkoxylated esters and alkyl polyglycosides. In some embodiments, multiple non-ionic surfactants such as non-ionic alcohols or non-ionic esters are combined. As a skilled artisan may appreciate, the surfactant(s) selection may vary depending upon such factors as salinity and clay content in the reservoir. The surfactants can be injected in any manner such as continuously or in a batch process.

In some embodiments, polymers are employed to control the mobility of the injection solution and improve sweep efficiency. In particular, polymers help to reduce channeling and help drive the residual oil through the reservoir formation. Such polymers include, but are not limited to, xanthan gum, partially hydrolyzed polyacrylamides (HPAM) and copolymers of 2-acrylamido-2-methylpropane sulfonic acid and/or sodium salt and polyacrylamide (PAM) commonly referred to as AMPS copolymer. Molecular weights (Mw) of the polymers generally range from about 10,000 daltons to about 20,000,000 daltons, such as about 100,000 to about 500,000, or about 300,000 to 800,000 daltons. Polymers are typically used in the range of about 250 ppm to about 5,000 ppm, such as about 500 to about 2500 ppm concentration, or about 1000 to 2000 ppm in order to match or exceed the reservoir oil viscosity under the reservoir conditions of temperature and pressure. Examples of polymers include Flopaam™ AN125 and Flopaam™ 3630S, which are produced by and available from SNF Floerger, headquartered in Andrézieux, France.

### EXPERIMENTS/EXAMPLES

Several factors affect the performance of a metal complexing agent or a scale inhibitor such as, metal binding capacity of the structure, the stability and the water solubility of the metal complex that is formed, pH and temperature. Theoretical calculations to determine the presence of scaling can be performed using a software called ScaleSoftPitzer™, which is a Microsoft™ Excel™ based program that can be used to predict scale tendency in oil and gas production systems. Scale tendency can be calculated for a system using the following equation:

(SI)=Log {[Ca²⁺(aq)]*[CO₃²⁻(aq)]/Kₛₚ}

where,

Kₛₚ(calcite)=[Ca²⁺(aq)]*[CO₃²⁻(aq)]/[CaCO₃(s)]

For example, the calcite scale index (SI) is zero and no calcite scale is expected for an actual field brine having a naturally acidic pH (contains dissolved CO₂) under reservoir conditions where the field brine is in equilibrium with the formation keeping the brine pH values low (about pH 6). However, for this brine sample, (SI) reaches 2.36 at a pH value of 9 and calcite scale potential becomes high. Note that this is still at or below the pH value for a typical alkaline flood.

Eight different metal complexing agents and five commercial scale inhibitors were tested according to known laboratory methods with a synthetic brine containing 1,000 ppm of divalent cation (Ca²⁺/Mg²⁺) and 450 ppm of HCO₃⁻. Among the complexing agents tested, six were organic ligands with carboxylate moieties and two were inorganic phosphates. The five scale inhibitors tested were commercial products supplied by Nalco Chemicals based on phosphonate, acrylate and sulfonate. The initial screening results with organic and inorganic complexing agents and scale inhibitors are provided in the below tables.

| | | | Maximum |
|---|---|---|---|
| Complexing Agents | | Result | pH |
| Organic | Sodium ethylenediamine | + | 10.7 |
| Agents | tetraacetate (EDTA-Na₄) | | |
| | Sodium nitrilotriacetate | − | |
| | (Na₃-NTA, Na₃C₆H₉NO₆) | | |
| | Sodium citrate (Na₃C₆H₅O₇) | − | |
| | Sodium maleate monohydrate | + | 10.2 |
| | (C₄H₄Na₂O₅•H₂O) | | |
| | Sodium succinate hexahydrate | + | 10.2 |
| | (C₄H₆O₄Na₂•6H₂O) | | |
| | Sodium polyacrylate | − | |
| | (—CH2—CH(CO2Na)— | | |
| Inorganic | Sodium tripolyphosphate | − | |
| Agents | (Na₅P₃O₁₀) | | |
| | Tetrapotassium pyrophosphate | − | |
| | (K₄P₂O₇) | | |

| | | Maximum |
|---|---|---|
| Scale Inhibitors | Result | pH |
| DVE4O007: polyacrylate-based inhibitor | − | |
| EC6157A: polyvinyl sulfonate-based inhibitor | + | 9.2 |
| VX9400: polyvinyl sulfonate-based inhibitor | + | 9.5 |
| DVE4O005: phosphonate-based inhibitor | + | 9.6 |
| EC6085A: phosphonate-based inhibitor | + | 9.4 |

Scale prevention capacity of the metal complexing agents were then tested using the following bottle test procedure:
1. Synthetic field brine was prepared with NaCl and NaHCO₃ (constituents of the brine) but CaCl₂ and MgCl₂ content was temporarily withheld to avoid premature scaling.
2. Metal complexing agent was added to the brine above in a stoichiometrically required amount and at higher concentrations and the solution was allowed to equilibrate after thorough mixing.
3. CaCl₂ and MgCl₂ were added and the brine solutions were equilibrated.
4. In a preliminary test, the impact of pH alone was evaluated. The pH of the brine was raised to above 10.0 by addition of hydroxide NaOH solution (or sodium metaborate Na₂B₂O₄, with less tendency to scale than Na₂CO₃) while the solution was observed for scale formation.
5. If no scale was observed, step 4 was repeated with addition of Na₂CO₃.

The table below shows bottle test screening details with the metal complexing agents:

| | Agent | | | Status | Status |
|---|---|---|---|---|---|
| Complexing | concentra- | Alkali | | (same | (next |
| agent | tion (%) | added | pH | day) | day) |
| EDTA-Na₄ | 1.1 | Na₂CO₃ | 10.60 | clear | clear |
| EDTA-Na₄ | 1.1 | Na₂CO₃ | 10.69 | clear | clear |
| EDTA-Na₄ | 1.1 | Na₂CO₃ | 10.77 | clear | clear |
| EDTA-Na₄ | 1.1 | Na₂B₂O₄ | 9.97 | clear | clear |
| EDTA-Na₄ | 1.1 | Na₂B₂O₄ | 10.10 | clear | clear |
| EDTA-Na₄ | 1.1 | Na₂B₂O₄ | 10.15 | clear | clear |
| NTA-Na₃ | 0.8 | — | | scale | scale |
| NTA-Na₃ | 1.1 | — | | scale | scale |
| NTA-Na₃ | 1.5 | — | | scale | scale |
| Sodium | 1.15 | — | | scale | scale |
| tripolyphosphate | | | | | |
| Sodium | 1.25 | — | | scale | scale |
| tripolyphosphate | | | | | |
| Sodium | 1.50 | — | | scale | scale |
| tripolyphosphate | | | | | |
| Sodium citrate | 0.8 | Na₂B₂O₄ | 10.10 | clear | scale |
| Sodium citrate | 1.5 | Na₂B₂O₄ | 10.10 | clear | scale |
| Sodium citrate | 1.5 | Na₂CO₃ | 10.10 | scale | scale |
| Tetrapotassium | 1.5 | NaOH | 8.80 | scale | scale |
| Sodium maleate | 1.5 | NaOH | 10.20 | clear | clear |
| Sodium succinate | 1.5 | NaOH | 10.20 | clear | clear |
| Sodium | 1.5 | NaOH | 5.50 | scale | scale |
| polyacrylate | | | | | |

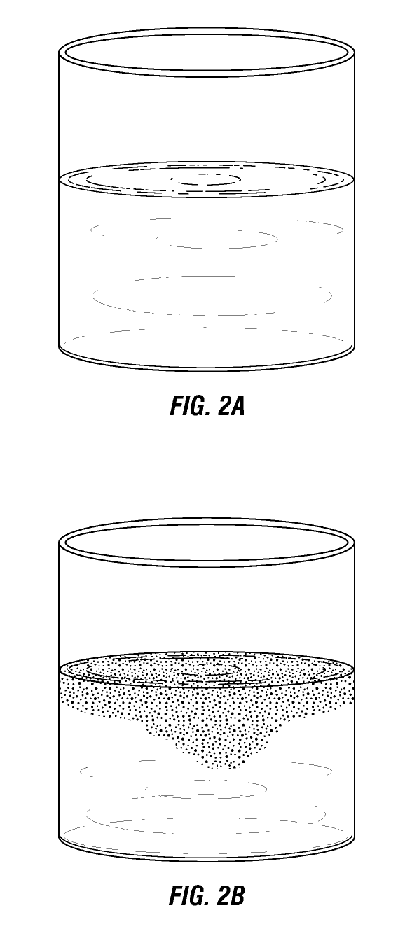

FIG. 2A shows an example of a clear, aqueous stable solution. Here, the complexing agent forms a water soluble complex with the metal cations so that they will not interact with other ions to create precipitation. Accordingly, a homogenous and phase stable solution that is free of suspended particles, rather than being a mixture that separates into multiple phases over time, is produced. FIG. 2B shows an example of a solution having particles or large aggregates floating therein. Here the complexes formed by the complexing agent and metal cation have poor water solubility and precipitate creating a hazy, translucent or opaque solution. Typically, if the injection fluid is not stable, it will separate into multiple phases within twenty-four (24) to forty-eight (48) hours. While a clear, aqueous stable solution is generally advantageous, in some embodiments, a slightly hazy solution can be utilized as it still is capable of preventing severe scaling and can be more economically feasible.

The following mechanisms can be used to help interpret the above results. Good solubility of the metal-ligand complex formed at high pH is an attribute of a successful complexing agent. “Multidentate” ligands, such as the ones used herein, can be present in many different forms in solution depending on the number of their acidic sites as well as the pH. EDTA for example, has a total of six speciations depending on the pH: H₆Y²⁺, H₅Y⁺, H₄Y, H₃Y⁻, H₂Y²⁻, HY³⁻, Y⁴ .

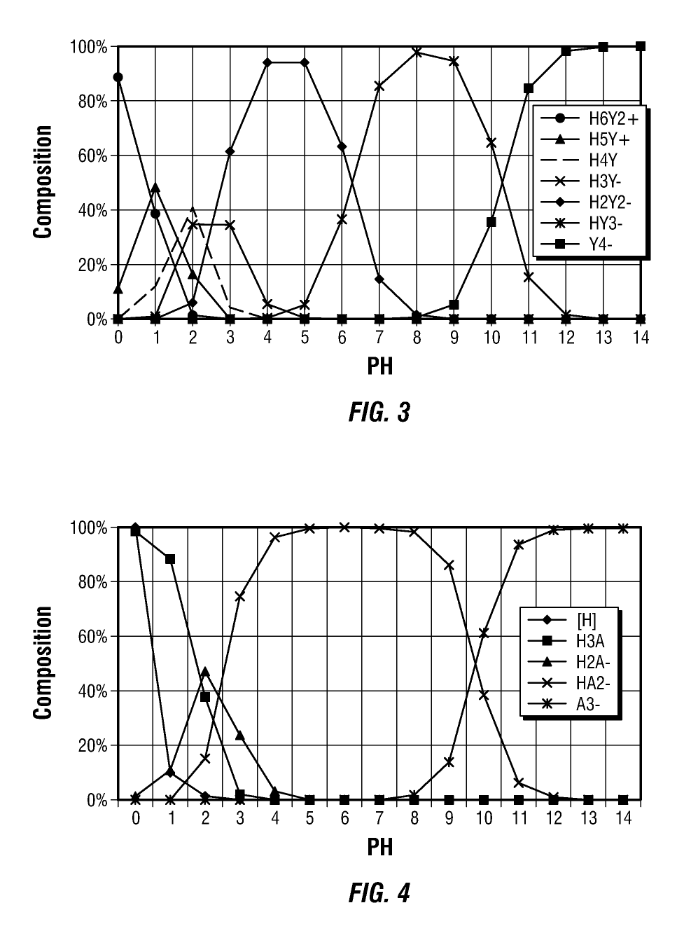

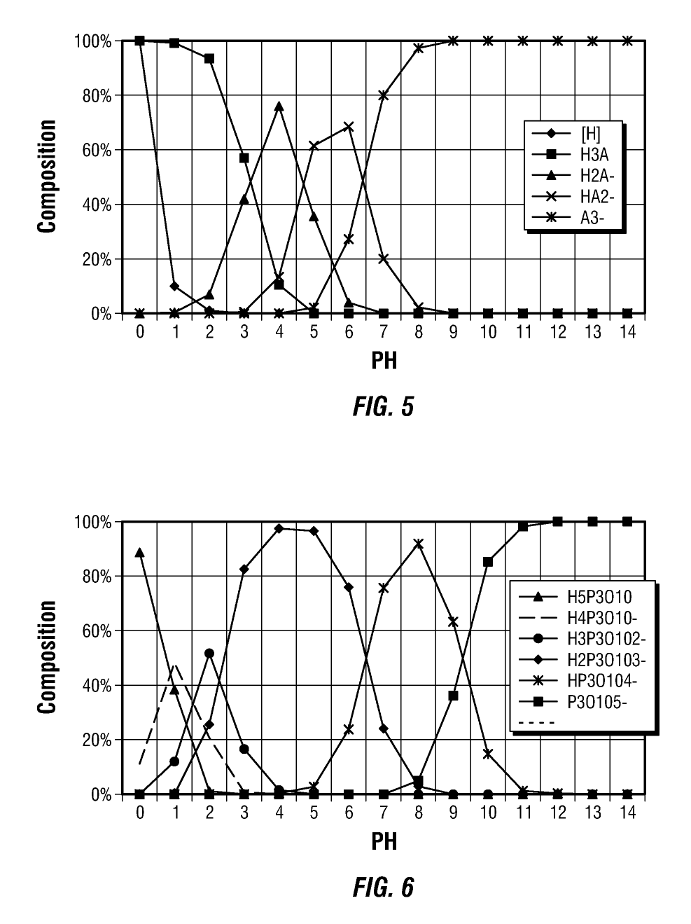

FIGS. 3-6 show speciation of metal complexing agents as a function of pH. In particular, FIG. 3 shows EDTA speciation, FIG. 4 shows NTA speciation, FIG. 5 shows citric acid speciation, and FIG. 6 shows phosphoric acid speciation.

When one of these complexing agents is added to brine containing HCO₃⁻ and the additional alkali is introduced by Na₂CO₃, the pH of the system is controlled by a two-buffer system: the carbonate/bicarbonate system and the metal complexing agent or ligand. First, the metal cations present in the solution are sequestered by the available ligand, and then the pH of the system is determined by the excess ligand concentration and the [HCO₃⁻] according to

pH=log([HCO₃]*K_{A2}*Kₐ₆/[L])^{0.5})

in which K_{A2} is for HCO₃⁻ [symbol] H +CO₃²⁻; Kₐ₆ is for HY³⁻ [symbol] H⁺+Y⁴⁻ equilibria; and [L] is the remaining concentration of ligand after complexing with Ca, Mg and Na.

In highly buffered brines, the pH of the system is not only determined by the initial alkali content, but is also managed by the added complexing agent that in return dictates the solubility of the ligand/metal composites and controls the performance of the metal complexing agent.

### Solubility of the Complexes

For EDTA, the solubility generally increases with pH. At 22° C., the solubility of H₄Y form is only 0.02 g/100 g, whereas that of Na2H2Y₂ form is 11.1 g/100 g. For an alkaline flooding application where pH is 9 or above, Na₃HY₃ or Na₄Y₄ forms are dominant The solubility of the EDTA-Metal complex formed with these species is high, as was seen in the tests.

For NTA, although in general, a polyaminocarboxylate ion forms a water soluble complex with a polyvalent metal ion, the complex formed by Ca, Na and NTA precipitates at a pH of 6.5. The solubility of the complex increases with temperature, and also with pH above pH 6.5. At pH 9, it is ˜1.0/100 ml solution.

Sodium Tripolyphosphate (Na₅P₃O₁₀): In aqueous solutions, water gradually hydrolyzes polyphosphates into smaller phosphates and finally into ortho-phosphate. Higher temperatures or acidic conditions speed up the hydrolysis reactions considerably. Phosphate salts are known to have very low solubilities in water except for ammonium and alkali metal salts. Although Na₃P₃O₁₀ water solubility is 14.5 g/100 mL and that of Na₃PO₄ is 8.8 g/100 mL at 25° C., calcium phosphate has a solubility of 0.8 ppm and calcium hydrogen phosphate of about 200 ppm at the same temperature. These are much below the concentrations of calcium and magnesium phosphate complexes that are formed in the sample brine and are largely the reason why scale was observed during bottle tests.

Although sodium citrate itself has very high solubility in water (42.5 g/100 mL at 25° C.) the solubility of calcium citrate complex is only 0.085 g/100 mL at 18° C., and 0.096 g/100 mL at 23° C. Considering the divalent cation content of the brine and associated concentration of sodium citrate needed for complexing based on 1 to 1 molar ratio, sodium citrate was not a successful selection.

For the purpose of illustration, and based on the above bottle test results, tetrasodium EDTA was selected as a complexing agent to further be tested. Although sodium maleate and sodium succinate also showed promising results, the minimum quantity of these agents for divalent cation sequestration is considerably higher than for EDTA. Different commercial grades of EDTA were acquired from BASF Chemicals and tested with and without scale inhibitors. In addition, a sodium methylglycinediacetic acid based agent that is available in powder and solution forms was also tested. The table below shows the EDTA and MGDA agents tested:

| COMPLEXING AGENT | ACTIVITY (%) |
|---|---|
| EDTA: Tetrasodium ethylenediamine | |
| tetraacetic acid | |
| TRILON B POWDER Na4EDTA 4H2O | 88 |
| TRILON B LIQUID Na4EDTA 4H2O | 40 |
| TRILON BX LIQUID Na4EDTA 4H2O | 40 |
| HEDTA: Trisodium ethylenediamine | |
| tetraacetic acid | |
| TRILON D LIQUID Na3HEDTA | 40 |
| MGDA: Trisodium | |
| methylglycinediacetic acid | |
| TRILON M LIQUID Na3MGDA | 40 |
| TRILON M POWDER Na3MGDA | 83 |

The initial bottles tests were designed at the reported calcium binding capacity of the agents without changing the pH. All of the brine solutions were initially clear and remained clear over time, except for the Trilon BX solution that turned hazy after a few days.

The table below shows initial screening details with the BASF complexing agents. In particular, the table below shows initial screening results of metal complexing capability of each complexing agent.

| | | CaCO₃ | Ca²⁺ | | | |
|---|---|---|---|---|---|---|
| | | Binding | Binding | | | |
| | | Capacity | Capacity | Concentration | | |
| Agent | Agent | (g CaCO3 | (g Ca | Used | | |
| ID | Type | per g Agent) | per g Agent) | (ppm) | pH | Result |
| TRILON B | EDTA | 0.225 | 0.090 | 11,000 | 10.2 | clear |
| POWDER | | | | | | |
| TRILON B | EDTA | 0.102 | 0.041 | 24,000 | 10.9 | clear |
| LIQUID | | | | | | |
| TRILON BX | EDTA | 0.102 | 0.041 | 24,000 | 11.3 | slightly |
| LIQUID | | | | | | hazy |
| TRILON D | HEDTA | 0.125 | 0.050 | 20,000 | 10.3 | clear |
| LIQUID | | | | | | |
| TRILON M | MGDA | 0.332 | 0.133 | 7,350 | 9.9 | clear |
| POWDER | | | | | | |

A variety of scale inhibitors were tested in the same field brine composition to observe their capability in preventing scale formation at high pH values. The table below shows bottle test screening results with the scale inhibitors.

| | Agent | | | Status | Status |
|---|---|---|---|---|---|
| | concentra- | Alkali | | (same | (next |
| Scale inhibitor | tion (%) | added | pH | day) | day) |
| Polyacrylate-based | 0.02 | NaOH | 9.0 | hazy | hazy |
| inhibitor | | | | | |
| polyvinyl | 0.02 | NaOH | 9.2 | clear | clear |
| sulfonate based | | | | | |
| inhibitor | | | | | |
| polyvinyl | 0.02 | NaOH | 9.5 | clear | clear |
| sulfonate-based | | | | | |
| inhibitor 2 | | | | | |
| Phosphonate-based | 0.02 | NaOH | 9.6 | clear | clear |
| inhibitor | | | | | |
| Phosphonate-based | 0.02 | NaOH | 9.4 | clear | clear |
| inhibitor 2 | | | | | |

Based on the above results, two commercial scale inhibitors were combined in synthetic brine with the metal complexing agents. The pH of the solutions was raised by addition of 1.0M NaOH to simulate the basic environment during an alkaline flood. All solutions were initially clear at pH values listed in the table above. The following procedure was used to prepare the aqueous solutions:
1. Synthetic field brine was prepared by temporarily excluding the HCO₃⁻.
2. Scale inhibitor was added and the solution was allowed to equilibrate after thorough mixing.
3. Metal complexing agent was added to the brine above in concentrations near half of the stoichiometrically required amount and the solution was allowed to equilibrate after thorough mixing.
4. NaHCO₃ was added and the brine solutions were equilibrated.
5. The pH of the brine was raised to above 10.0 by addition of Na₂B₂O₄ or NaOH solution while the solution was observed for scale formation.

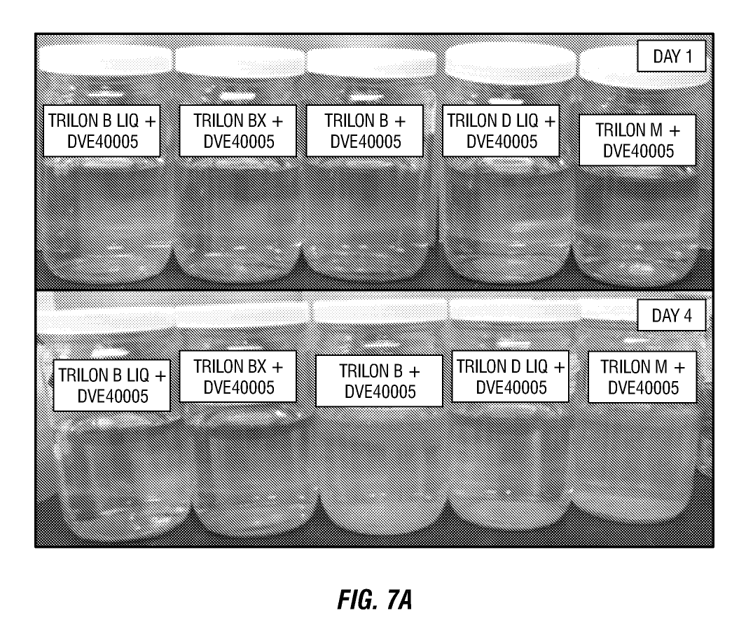

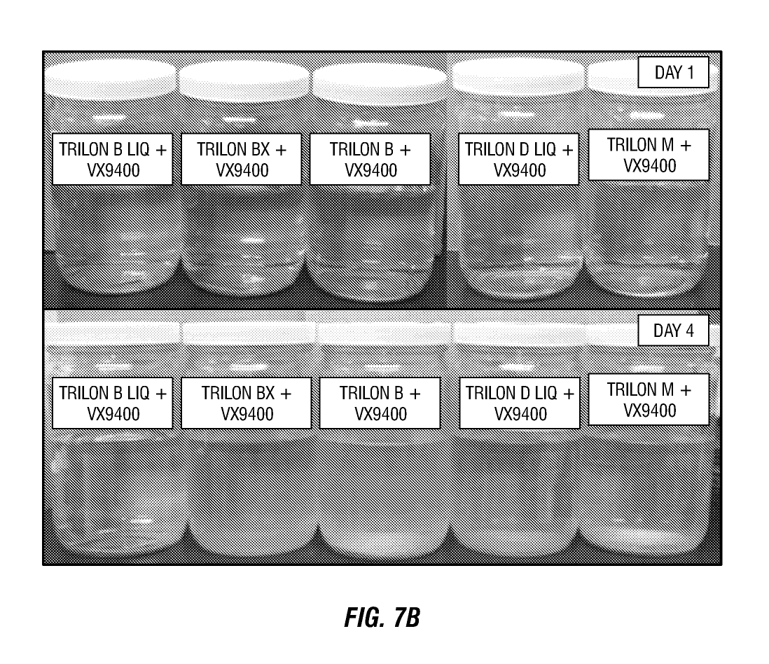

FIGS. 7A and 7B show bottle test results with the BASF complexing agents and the Nalco scale inhibitors. All of the brine solutions showed some amount of scale formation in time except for the TRILON B LIQUID solution. The table below shows bottle test details with BASF complexing agents and Nalco scale inhibitors.

| | | | | Scale | | | |
|---|---|---|---|---|---|---|---|
| | | Scale | Complexing | Inhibitor | | Result | Result |
| Agent | Agent | Inhibitor | Agent Conc. | Conc. | | (Same | (4 days |
| ID | Type | Type | (ppm) | (ppm) | pH | Day) | later) |
| TRILON B | EDTA | phosphonate | 5,500 | 200 | 10.6 | clear | scale |
| POWDER | | | | | | | |
| TRILON B | EDTA | phosphonate | 12,000 | 200 | 9.9 | clear | clear |
| LIQUID | | | | | | | |
| TRILON BX | EDTA | phosphonate | 12,000 | 200 | 10.3 | clear | slightly |
| LIQUID | | | | | | | hazy |
| TRILON D | HEDTA | phosphonate | 10,000 | 200 | 10.6 | clear | slightly |
| LIQUID | | | | | | | hazy |
| TRILON M | MGDA | phosphonate | 3,750 | 200 | 10.6 | clear | very |
| POWDER | | | | | | | minor |
| | | | | | | | scale |
| TRILON B | EDTA | polyvinyl | 5,500 | 200 | 10.6 | clear | scale |
| POWDER | | sulfonate | | | | | |
| TRILON B | EDTA | polyvinyl | 12,000 | 200 | 9.9 | clear | clear |
| LIQUID | | sulfonate | | | | | |
| TRILON BX | EDTA | polyvinyl | 12,000 | 200 | 10.1 | clear | scale |
| LIQUID | | sulfonate | | | | | |
| TRILON D | HEDTA | polyvinyl | 10,000 | 200 | 10.6 | clear | scale |
| LIQUID | | sulfonate | | | | | |
| TRILON M | MGDA | polyvinyl | 3,750 | 200 | 10.6 | clear | scale |
| POWDER | | sulfonate | | | | | |

Based on these results, a final group of experiments was performed focusing around formulations that can prevent scale at lower agent concentrations in the presence of scale inhibitors. The table below shows bottle test details with the BASF complexing agents and the Nalco scale inhibitors.

| | Result |
|---|---|
| Agents | (in 4 days)/pH |
| TRILON M LIQUID | Clear |
| 17,250 ppm | 10.35 |
| TRILON M LIQUID | Hazy |
| 8,500 ppm + | 9.8 |
| DVE400O5 200 ppm | |
| TRILON M LIQUID | Hazy |
| 8,500 ppm + | 9.9 |
| VX9400 200 ppm | |
| TRILON B 5,500 ppm + | Hazy |
| DVE400O5 200 ppm | 9.4 |
| TRILON B 6,500 ppm + | Hazy |
| VX9400 200 ppm | 10.0 |
| TRILON B 6,500 ppm + | Hazy |
| VX9400 350 ppm | 10.0 |
| TRILON M 5,500 ppm + | Clear |
| VX9400 500 ppm | 10.35 |
| TRILON D LIQUID | Hazy |
| 10,000 ppm + | 9.8 |
| DVE400O5 200 ppm | |
| TRILON D LIQUID | Hazy |
| 8,000 ppm + | 9.5 |
| DVE400O5 200 ppm | |
| TRILON M 5,500 ppm + | Hazy |
| DVE400O5 200 ppm | 10.3 |
| TRILON M 3,750 ppm + | Hazy |
| DVE400O5 200 ppm | 9.7 |
| TRILON B 6,500 ppm + | Hazy |
| VX9400 500 ppm | 10.3 |
| TRILON B 7,500 ppm + | Slightly Hazy |
| DVE4O005 500 ppm | 10.35 |
| TRILON M 8,500 ppm | Scale |
| TRILON B LIQUID | Scale |
| 8,000 ppm + | 9.2 |
| VX9400 200 ppm | |
| TRILON D LIQUID | Scale |
| 10,000 ppm + | 9.4 |
| VX9400 200 ppm | |
| TRILON B 5,500 ppm + | Hazy |
| VX9400 200 ppm | 9.5 |
| TRILON B 7,500 ppm + | Clear |
| VX9400 200 ppm | 10.3 |
| TRILON M 6,500 ppm + | Hazy |
| VX9400 200 ppm | 10.3 |
| TRILON M 6,500 ppm + | Scale |
| VX9400 500 ppm | |
| TRILON B 7,500 ppm + | Slightly Hazy |
| DVE400O5 200 ppm | 9.4 |
| TRILON B LIQUID | Hazy |
| 8,000 ppm + | 9.4 |
| DVE400O5 200 ppm | |
| TRILON M 5,500 ppm + | Hazy |
| VX9400 200 ppm | 10.3 |
| TRILON M 3,750 ppm + | Hazy |
| VX9400 200 ppm | 9.7 |
| TRILON M-TRILON B | Hazy |
| 3000 ppm/ea + | 10.3 |
| DVE400O5 300 ppm | |
| TRILON M-TRILON B | Slightly |
| 3000 ppm/ea + | Hazy |
| VX9400 300 ppm | 10.3 |

Two new formulations proved to prevent scale at lower agent concentrations up to pH values of 10.3 and their solutions remained clear in time. Those were: 5,500 ppm Trilon M with 500 ppm VX9400 and 7,500 ppm TRILON B with 200 ppm VX9400. Two other formulations were able to prevent scale initially, even though solutions turned slightly hazy after a day. Those were: 7,500 ppm TRILON B with 500 ppm DVE40005 and (3000 ppm TRILON M/3000 ppm TRILON B) with 300 ppm DVE40005.

Therefore, in the above experiments, six (6) organic and two (2) inorganic metal complexing agents, and a variety of commercial scale inhibitors were tested to prevent scale formation in hard field brine. The field brine in the above experiments had nearly 1,000 ppm Ca²⁺/Mg²⁺ and 450 ppm HCO₃⁻ at pH 6 (Scale index, SI=0 at reservoir conditions). During alkaline flooding, when the pH was increased to above 9, CaCO₃ and MgCO₃ scale occured (SI=2.36). In order to prevent scaling, the divalent cations can be captured by addition of organic complexing agents that form water-soluble complexes with metal cations in brine. A working formulation with 11,000 ppm of an organic complexing agent was developed that can prevent scale formation up to pH values 10.5. The scale prevention capacity of different commercial scale inhibitors was also tested alone and in combination with the mentioned complexing agents. Addition of 200 to 500 ppm of phosphonate or polyvinyl sulfonate based scale inhibitor helps drop the complexing agent concentration needed to prevent scale formation down to 5,500 ppm at pH values of 10.3 or less. Furthermore, the following items were observed for this example brine:
1. The inorganic complexing agents investigated were not capable of preventing scaling in hard brine at a pH value of above 10.
2. Scale inhibitors tested alone at 200 ppm prevented scaling up to a pH value of 9.6 or below.
3. 11,000 ppm EDTA-Na4 in hard field brine (equimolar Ca:EDTA) was effective up to a pH value 10.7.
4. MGDA at equimolar concentration (7,350 ppm) with the calcium ions prevented scaling using hard brine up to a pH value of 9.9.
5. The key mechanism to prevent scaling with organic ligands is the solubility of the Ca-Ligand complexes as the pH exceeds a value of 10. Many ligands are capable of preventing scale below a pH value of 10 (clear solution) but the Ca-Ligand complexes began to precipitate above a pH value of 10, the threshold for saponification.
6. EDTA concentration may be reduced to 7,500 ppm when used in combination with 200 ppm of a polyvinyl sulfonate based scale inhibitor (VX9400 by Nalco Chemicals). Thus, the addition of the scale inhibitor lowered the concentration of complexing agent to metal cations from about a 1.00:1.00 molar ratio to approximately a 0.66:1.00 molar ratio.
7. MGDA concentration may be reduced to 5,500 ppm when used in combination with 500 ppm of a polyvinyl sulfonate based scale inhibitor (VX9400 by Nalco Chemicals). Thus, the addition of the scale inhibitor lowered the concentration of complexing agent to metal cations from about a 1.00:1.00 molar ratio to approximately a 0.65:1.00 molar ratio.
8. The high cost of organic complexing agents may be justified in offshore applications where the costs of additional deck space for water treatment (softening or desalination) are prohibitive.

Accordingly, the divalent cations can bind in formation brine by addition of different complexing agents. The complexing agent forms aqueous soluble cation-ligand complexes with the metal cations so that they will not interact with other ions to create precipitation. This method can be used as a surrogate to water-softening as it is easier to implement in the field and can be much more cost-effective.

As used in this specification and the following claims, the terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent of the given numeric value provided such a deviation does not alter the end function or result of the value. Therefore, a value of about 1% can be construed to be a range from 0.9% to 1.1%.

While in the foregoing specification this invention has been described in relation to certain preferred embodiments thereof, and many details have been set forth for the purpose of illustration, it will be apparent to those skilled in the art that the invention is susceptible to alteration and that certain other details described herein can vary considerably without departing from the basic principles of the invention.

What is claimed is:

1. A method for preventing scale formation during an alkaline hydrocarbon recovery process, the method comprising:
(a) providing an aqueous solution having a concentration of metal cations;
(b) introducing a stoichiometric amount of an organic complexing agent relative to the concentration of metal cations into the aqueous solution such that the organic complexing agent forms aqueous soluble cation-ligand complexes with the metal cations;
(c) forming an injection fluid having a pH value of at least 10 by introducing at least one alkaline into the aqueous solution, wherein the cation-ligand complexes remain soluble in the injection fluid; and
(d) injecting the injection fluid into a subterranean reservoir.

2. The method of claim 1, wherein the aqueous solution comprises one of recovered sea water, water produced from the subterranean reservoir, or a combination thereof.

3. The method of claim 1, wherein the organic complexing agent is ethylenediaminetetraacetic acid.

4. The method of claim 1, wherein the organic complexing agent is methylglycinediacetic acid.

5. The method of claim 1, wherein the organic complexing agent is introduced into the aqueous solution in a concentration of less than a 1:1 molar ratio with the metal cations.

6. The method of claim 1, wherein:
the metal cations comprise calcium cations; and
the cation-ligand complexes comprise calcium-ligand complexes.

7. The method of claim 1, wherein:
the metal cations comprise magnesium cations; and
the cation-ligand complexes comprise magnesium-ligand complexes.

8. The method of claim 1, further comprising introducing a scale inhibitor into the aqueous solution prior to step (c).

9. The method of claim 8, wherein the scale inhibitor is introduced in a concentration of from 100 parts per million to 600 parts per million.

10. The method of claim 8, wherein the scale inhibitor comprises a phosphonate or polyvinyl sulfonate based scale inhibitor.

11. The method of claim 8, wherein the organic complexing agent is introduced into the aqueous solution in a concentration of a 0.65:1 molar ratio with the metal cations.

12. The method of claim 1, wherein water softening of the aqueous solution is solely performed by sequestering the metal cations with the organic complexing agent.

13. A method for preventing scale formation during an alkaline hydrocarbon recovery process, the method comprising:
(a) providing an aqueous solution having a concentration of at least one of calcium and magnesium cations;
(b) introducing a stoichiometric amount of an organic complexing agent relative to the concentration of calcium and magnesium cations into the aqueous solution such that the organic complexing agent forms at least one of aqueous soluble calcium-ligand complexes with the calcium cations and aqueous soluble magnesium-ligand complexes with the magnesium cations;
(c) forming an injection fluid having a pH value of at least 10 by introducing at least one alkaline into the aqueous solution, wherein the calcium-ligand complexes and the magnesium-ligand complexes remain soluble in the injection fluid; and
(d) injecting the injection fluid into a subterranean reservoir.

14. The method of claim 13, wherein the aqueous solution comprises one of recovered sea water, water produced from the subterranean reservoir, or a combination thereof.

15. The method of claim 13, wherein the organic complexing agent is ethylenediaminetetraacetic acid or methylglycinediacetic acid.

16. The method of claim 13, wherein the organic complexing agent is introduced into the aqueous solution in a concentration of less than a 1:1 molar ratio with the calcium and magnesium cations.

17. The method of claim 13, further comprising introducing a scale inhibitor into the aqueous solution in a concentration of from 100 parts per million to 600 parts per million prior to step (c).

18. The method of claim 17, wherein the scale inhibitor comprises a phosphonate or polyvinyl sulfonate based scale inhibitor.

19. The method of claim 17, wherein the organic complexing agent is introduced into the aqueous solution in a concentration of a 0.65:1 molar ratio with the calcium and magnesium cations.

20. The method of claim 13, wherein water softening of the aqueous solution is solely performed by sequestering the metal cations with the organic complexing agent.
